(19) United States
(12) Patent Application Publication
(10) Pub. No.: US 2015/0278473 A1
(43) Pub. Date: Oct. 1, 2015

(54) METHOD AND APPARATUS FOR PROVIDING PRESCRIPTION MEDICATION

(71) Applicant: Mehmed Ugur, Monmouth Junction, NJ (US)

(72) Inventor: Mehmed Ugur, Monmouth Junction, NJ (US)

(21) Appl. No.: 14/227,821

(22) Filed: Mar. 27, 2014

(51) Int. Cl. G06F 19/00; G06Q 50/22

(52) U.S. Cl. CPC G06F 19/3456; G06Q 50/22

(57) ABSTRACT

A computer readable medium including computer executable instructions which, when executed by a computer processor, display a take photograph field on a mobile communications device computer display, wherein when the take photograph field is selected a digital photograph of a prescription for medicine is taken by the mobile communications device, and stored in a computer memory; and send data concerning the digital photograph from the mobile communications device to a pharmacist computer device via the internet. The computer executable instructions when executed by the computer processor, may additionally perform the steps of displaying on the mobile communications device computer display a name and a dosage amount for the medicine, and of displaying a medicine taken field, wherein the medicine taken field when selected causes the mobile communications device to send a message to a caregiver computer device via the internet to indicate that the medicine has been taken.

### FIELD OF THE INVENTION

This invention relates to improved methods and apparatus concerning providing prescription medications.

### BACKGROUND OF THE INVENTION

There is a need to increase patients' compliance with requirements for prescription medication. Proper use of prescription medications reduces admittance and/or re-admittance rates into hospitals.

### SUMMARY OF THE INVENTION

In at least one embodiment of the present invention a computer readable medium is provided comprising computer executable instructions which, when executed by a computer processor, perform the steps of displaying a take photograph field on a mobile communications device computer display, wherein when the take photograph field is selected a digital photograph of a prescription for medicine is taken by the mobile communications device, and stored in a computer memory by the mobile communications device; and sending data concerning the digital photograph from the mobile communications device to a pharmacist computer device via the internet.

The computer executable instructions when executed by the computer processor, may additionally perform the step of displaying on the mobile communications device computer display a name and a dosage amount for the medicine. The computer executable instructions when executed by the computer processor, may additionally perform the step of displaying on the mobile communications device computer display a medicine taken field, wherein the medicine taken field when selected causes the mobile communications device to send a message to a caregiver computer device via the internet to indicate that the medicine has been taken. The computer executable instructions when executed by the computer processor, may additionally perform the step of displaying on the mobile communications device computer display a medicine not taken field, wherein the medicine not taken field when selected causes the mobile communications device to send a message to a caregiver computer device via the internet to indicate that the medicine has not been taken.

One or more embodiments of the present application may include a method comprising the steps of taking a digital photograph of a prescription for medicine with a mobile communications device; and sending data concerning the digital photograph from the mobile communications device to a pharmacist computer device via the internet. The method may further include displaying on the mobile communications device computer display a name and a dosage amount for the medicine. The method may further include displaying on the mobile communications device computer display a medicine taken field, wherein the medicine taken field when selected causes the mobile communications device to send a message to a caregiver computer device via the internet to indicate that the medicine has been taken. The method may further include displaying on the mobile communications device computer display a medicine not taken field, wherein the medicine not taken field when selected causes the mobile communications device to send a message to a caregiver computer device via the internet to indicate that the medicine has not been taken.

### BRIEF DESCRIPTION OF THE DRAWINGS

FIG. 1A shows a block diagram of a user computer for use with an embodiment of the present invention;

FIG. 1B shows a block diagram of a server computer for use with an embodiment of the present invention;

FIG. 2 shows a simplified diagram of a user computer display of the user computer of FIG. 1A, with a first image shown on the user computer display;

FIG. 3 shows a simplified diagram of the user computer display of the user computer of FIG. 1A, with a second image shown on the user computer display;

FIG. 4 shows a simplified diagram of the user computer display of the user computer of FIG. 1A, with a third image shown on the user computer display;

FIG. 5 shows a flow chart of a method in accordance with another embodiment of the present invention;

FIG. 6 shows a simplified diagram of the user computer display of the user computer of FIG. 1A, with a fourth image shown on the user computer display;

FIG. 7 shows a simplified diagram of the user computer display of the user computer of FIG. 1A, with a fifth image shown on the user computer display;

FIG. 8 shows a simplified diagram of the user computer display of the user computer of FIG. 1A, with a sixth image shown on the user computer display;

FIG. 9 shows a flow chart of another method in accordance with another embodiment of the present invention;

FIG. 10 shows a simplified diagram of the user computer display of the user computer of FIG. 1A, with a seventh image shown on the user computer display;

FIG. 11 shows a simplified diagram of the user computer display of the user computer of FIG. 1A, with a eighth image shown on the user computer display;

FIG. 12 shows a simplified diagram of the user computer display of the user computer of FIG. 1A, with a ninth image shown on the user computer display; and

FIG. 13 shows a simplified diagram of the user computer display of the user computer of FIG. 1A, with a tenth image shown on the user computer display.

### DETAILED DESCRIPTION OF THE DRAWINGS

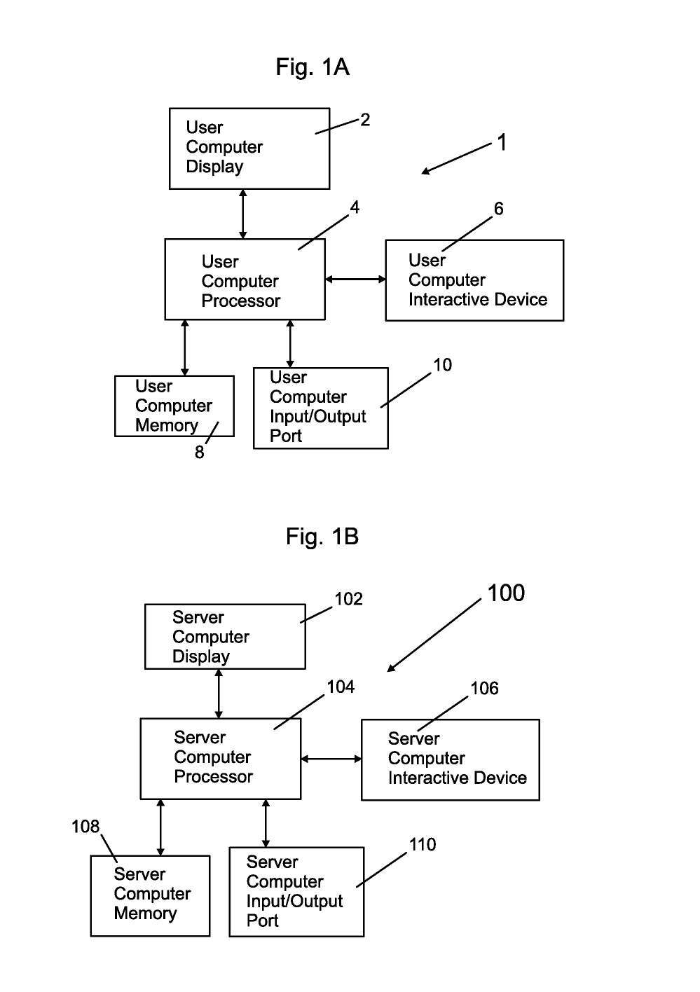

FIG. 1A shows a block diagram of a user computer 1 for use with an embodiment of the present invention. The user computer 1 includes a user computer display 2, a user computer processor 4, a user computer interactive device 6, a user computer memory 8, and a user computer input/output port 10. Each of the user computer display 2, the user computer interactive device 6, the user computer memory 8, and the user computer input/output port 10 may be electrically connected by communications links to the user computer processor 4, such as by hardwired, wireless, or any other known communications links. The user computer input/output port 10 may connect the user computer 1 to the internet wirelessly, through a cable, or in any other known manner. The user computer 1 may be a mobile electronic device such as a mobile smart phone or a computer tablet, or a lap top computer. The user computer interactive device 6 may include a computer keyboard, a computer mouse, a touch screen, or any other known computer interactive device.

FIG. 1B shows a block diagram of a server computer 100 for use with an embodiment of the present invention. The server computer 100 includes a server computer display 102, a server computer processor 104, a server computer interactive device 106, a server computer memory 108, and a server computer input/output port 110. Each of the server computer display 102, the server computer interactive device 106, the server computer memory 108, and the server computer input/output 110 may be electrically connected by communications links to the server computer processor 104, such as by hardwired, wireless, or any other known communications links. The server computer interactive device 106 may include a computer keyboard, a computer mouse, a touch screen, or any other known computer interactive device.

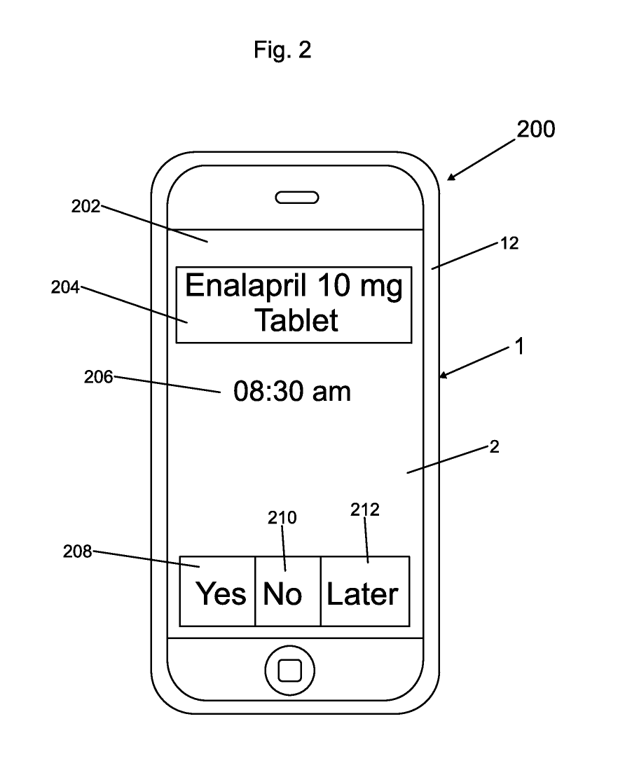

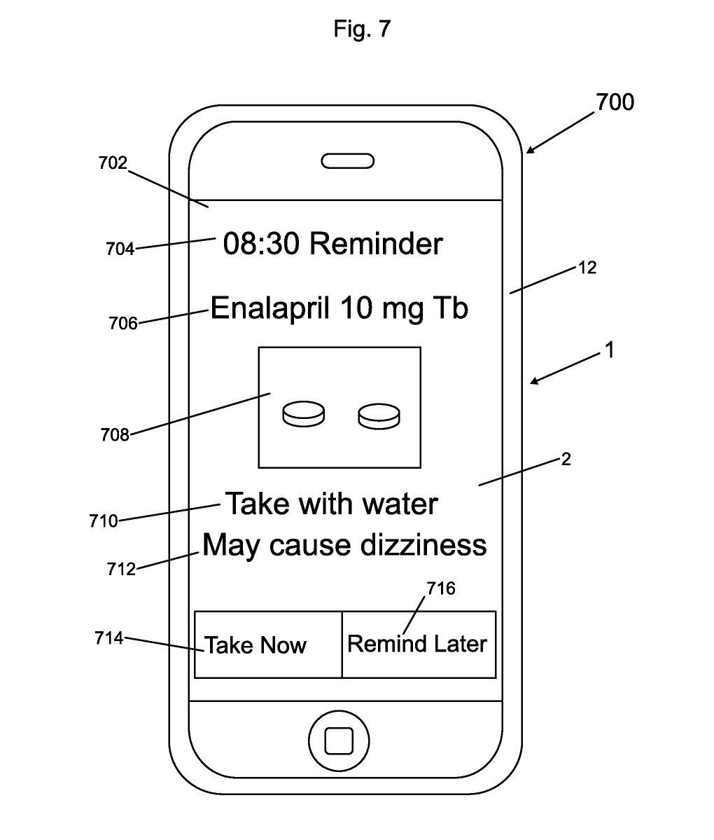

FIG. 2 shows a simplified diagram 200 of a user computer display 2 of the user computer 1 of FIG. 1A, with a first image 202 shown on the user computer display 2. The user computer 1 is shown as a smart phone in FIG. 2. The first image 202 includes a field 204, text 206, and fields 208, 210, and 212. The field 204 shows a type of prescription drug, a dosage amount, and the form in which the prescription drug is taken, for example, in this case “Enalapril 10 mg tablet”. The field 204 can be selected to cause an image 702 as shown in FIG. 7 to be displayed on the computer display 2 of the user computer or smart phone 1.

The text 206 shows a current time, “8:30 a.m.” which may also be the time at which the drug shown in field 204 should be taken. The field 208 includes the word “Yes” and can be selected by a user to indicate that the drug shown in field 204 has been taken. The field 210 includes the word “No” and can be selected by a user to indicate that the drug shown in field 204 has not been taken. The field 212 includes the word “Later” and can be selected by a user to indicate that the drug shown in field 204 will be taken later.

A computer program stored in the computer memory 8 and/or the server computer memory 108 and executed by the user computer processor 4 and/or the server computer processor 104, causes the image 202 to be displayed on the computer display 2 in response to a user selecting a computer application program on the user computer 1 and/or by a user downloading a computer application program or accessing a computer application program on the server computer 100. The processing of the selections of fields 204, 208, 210, and/or 212 is performed by the user computer processor 4 and/or the server computer processor 104 implementing one or more computer programs stored in the computer memory 8 and/or the computer memory 108.

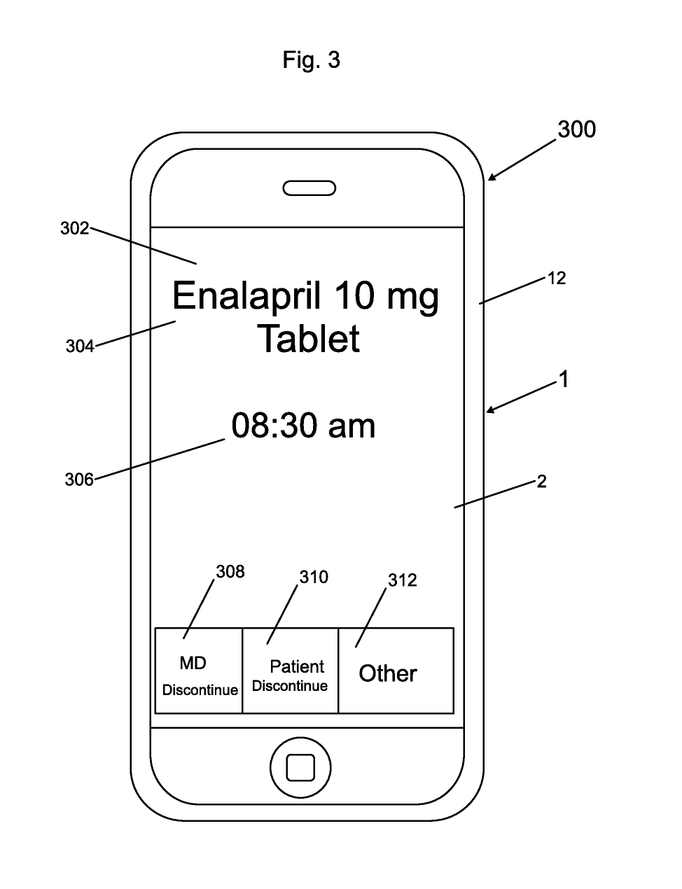

FIG. 3 shows a simplified diagram 300 of a user computer display 2 of the user computer 1 of FIG. 1A, with a second image 302 shown on the user computer display 2. The user computer processor 4 and/or the server computer processor 104 may cause the image 302 to be displayed on the computer display 2 in response to selection of the field 210 “No” shown in FIG. 2, in accordance with a computer program or programs stored in computer memory 8 and/or computer memory 108. The user computer 1 is shown as a smart phone in FIG. 3.

The second image 302 includes text 304, text 306, and fields 308, 310, and 312. The text 304 shows a type of prescription drug, a dosage amount, and the form in which the prescription drug is taken, for example, in this case “Enalapril 10 mg Tablet”. The text 306 shows a current time, “8:30 a.m.” which may also be the time at which the drug shown by text 304 should be taken. The field 308 includes the expression “MD Discontinue” and can be selected by a user to indicate that the drug shown by text 304 has not been taken because the drug has been discontinued by a medical doctor. The field 310 includes the expression “Patient Discontinue” and can be selected by a user to indicate that the drug shown by text 304 has not been taken, because the patient has discontinued its use. The field 312 includes the word “Other” and can be selected by a user to indicate that the drug shown by text 304 has not been taken for some other reason.

The processing of the selections of fields 308, 310, and/or 312 is performed by the user computer processor 4 and/or the server computer processor 104 implementing one or more computer programs stored in the computer memory 8 and/or the computer memory 108.

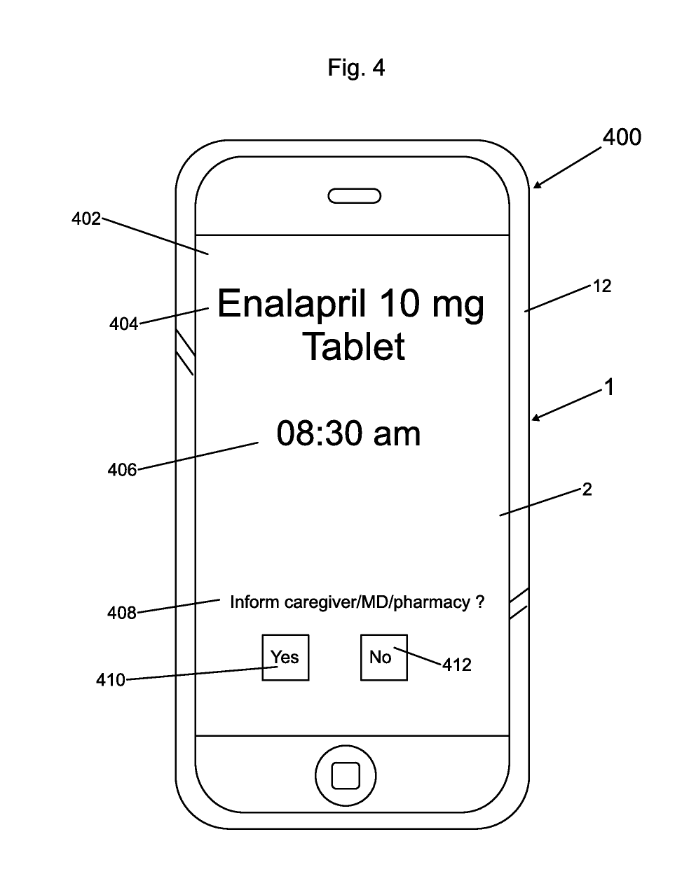

FIG. 4 shows a simplified diagram 400 of a user computer display 2 of the user computer 1 of FIG. 1A, with a third image 402 shown on the user computer display 2. The user computer processor 4 and/or the server computer processor 104 may cause the image 402 to be displayed on the computer display 2 in response to selection of the field 310 “Patient Discontinue” shown in FIG. 3, in accordance with a computer program or programs stored in computer memory 8 and/or computer memory 108. The user computer 1 is shown as a smart phone in FIG. 4.

The third image 402 includes text 404, text 406, text 408, and fields 410 and 412. The text 404 shows a type of prescription drug, a dosage amount, and the form in which the prescription drug is taken, for example, in this case “Enalapril 10 mg Tablet”. The text 406 shows a current time, “8:30 a.m.” which may also be the time at which the drug shown by text 404 should be taken. The text 408 includes the question “Inform caregiver/MD/pharmacy?” The field 410 includes the word “Yes” and can be selected by a user to cause a caregiver, MD, or pharmacy to be informed of the fact that the patient has discontinued their medication, such as by an email which may be sent out by the user computer 1 or smart phone. The field 412 includes the word “No” and can be selected by a user, if the user does not want to inform a caregiver, MD, or pharmacy of the patient's refusal to take medication.

The processing of the selections of fields 410, and/or 412 is performed by the user computer processor 4 and/or the server computer processor 104 implementing one or more computer programs stored in the computer memory 8 and/or the computer memory 108.

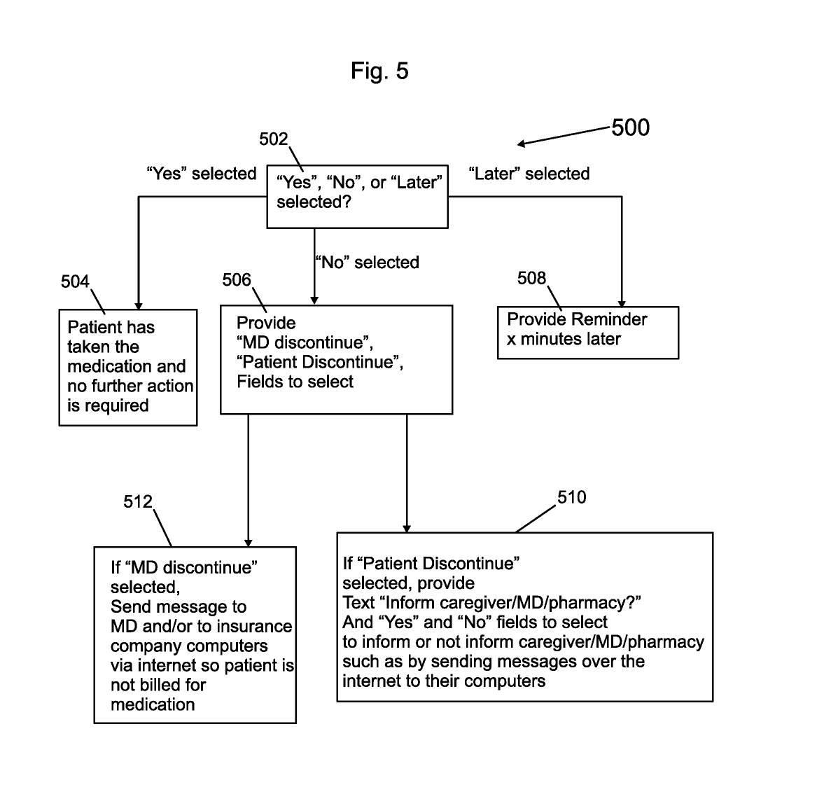

FIG. 5 shows a flow chart 500 of a method in accordance with another embodiment of the present invention. The flow chart 500 may be implemented by the user computer processor 4 and/or the server computer processor 104 implementing one or more computer programs stored in the computer memory 8 and/or the computer memory 108.

The flow chart 500 shows step 502 at which the computer processor 4 and/or 104 determines if the fields 208, 210, or 212 have been selected in FIG. 2 for “Yes”, “No”, or “Later” regarding whether the drug in field 204 has been taken. If “Yes” is selected the computer processor 4 and/or 104 then the patient has taken the medication and no further action is required at step 504. If “No” is selected, the computer processor 4 and/or 104 causes the image 302 of FIG. 3 to be displayed on the computer display 2, at step 506. If the “patient/discontinue” field 310 is selected in FIG. 3, then at step 510 of FIG. 5, the image 402 may be displayed by the computer processor 4 and/or 104 in accordance with a computer program or programs stored in computer memories 8 and/or 108. In addition, if the “patient/discontinue” field is selected at step 510, the computer processor 4 may be programmed to send a provide the “Inform caregiver/MD/pharmacy?” question and “Yes” and “No” fields to select to inform or not inform a caregiver/MD/Pharmacy such as by sending messages over the internet to a computer of a caregiver/MD/Pharmacy. At step 512 is “MD discontinue” is selected, then a message may be sent to an MD and/or to insurance company computers via internet so a patient is not billed for medication.

If the “Later” field 212 of FIG. 2 is selected then a reminder to take the drug is provided a certain amount of time later, such as for example x minutes later, wherein x may be for example ten, fifteen, or twenty minutes. The reminder may be in the form of an image displayed on the computer display 2, such as similar or identical to the image 202 shown in FIG. 2, however, the time for text 206 would typically change to a different time for each new reminder.

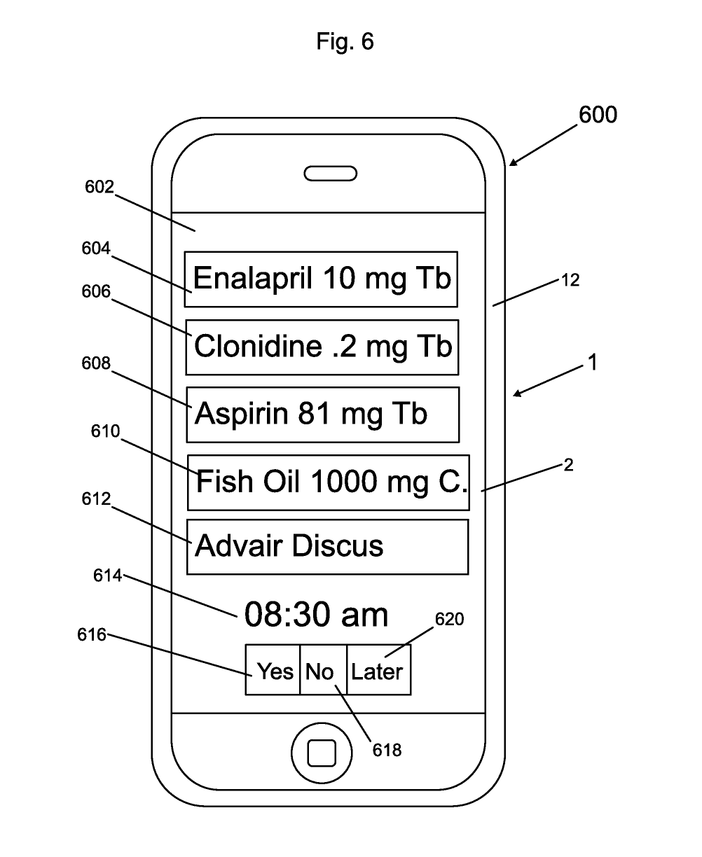

FIG. 6 shows a simplified diagram 600 of a user computer display 2 of the user computer 1 of FIG. 1A, with a fourth image 602 shown on the user computer display 2. The user computer 1 is shown as a smart phone in FIG. 6. The fourth image 602 includes fields 604. 606, 608, 610, and 612, text 614, and fields 616, 618, and 620. Each of the fields 604, 606, 608, 610, and 612 show a type of prescription drug, a dosage amount, and the form in which the prescription drug is taken, for example, in this case “Enalapril 10 mg Tb” for field 604. Each of fields 604, 606, 608, 610, and 612 can be individually selected to cause an image dealing with that specific drug to be displayed on the computer display 2 of the user computer 1. For example selection of field 604 causes the image 702 shown in FIG. 7 to be displayed on the computer display 2. Images analogous to image 702 are displayed upon selection of fields 606, 608, 610, and 612, with the exception that images for different drugs would be shown having different characteristics. I.e. selection of “Clonidine 0.2 mg Tb” will cause an image in the general format shown for image 702 to be displayed but having pictures and characteristics of “Clonidine” instead of “Enalapril”.

The text 614 shows a current time, “8:30 a.m.” which may also be the time at which the drug shown in fields 604, 606, 608, 610, and 612 should be taken. The field 616 includes the word “Yes” and can be selected by a user to indicate that the drugs shown in fields 604, 606, 608, 610, and 612 have been taken. The field 618 includes the word “No” and can be selected by a user to indicate that the drugs shown in fields 604, 606, 608, 610, and 612 have not been taken. The field 620 includes the word “Later” and can be selected by a user to indicate that the drugs shown in fields 604, 606, 608, 610, and 612 will be taken later.

A computer program stored in the computer memory 8 and/or the server computer memory 108 and executed by the user computer processor 4 and/or the server computer processor 104, causes the image 602 to be displayed on the computer display 2 in response to a user selecting a computer application program on the user computer 1 and/or by a user downloading a computer application program or accessing a computer application program on the server computer 100. The processing of the selections of fields 604, 606, 608, 610, 612, 616, 618, and 620 is performed by the user computer processor 4 and/or the server computer processor 104 implementing one or more computer programs stored in the computer memory 8 and/or the computer memory 108.

FIG. 7 shows a simplified diagram 700 of the user computer display 2 of the user computer 1 of FIG. 1A, with a fifth image 702 shown on the user computer display 2. The user computer processor 4 and/or the server computer processor 104 may cause the image 702 to be displayed on the computer display 2 in response to selection of the field 604 in FIG. 6 or field 204 in FIG. 2, in accordance with a computer program or programs stored in computer memory 8 and/or computer memory 108. The user computer 1 is shown as a smart phone in FIG. 3.

The fifth image 702 includes text 704, text 706, image 708, text 710, text 712, and fields 714, and 716. The text 704 indicates a time and the fact that this a reminder to take the drug referred to. The text 706 indicates the name of the drug, the amount, and the form it is in. The image 708 shows a picture of the drug of text 706 in tablet form. The text 710 includes instructions on how to take the drug, such as “Take with water”. The text 712 indicates side effects of the drug, such as “May cause dizziness”. The field 714 can be selected to indicate that a patient is taking the drug now, which results in no further action being required at this time. The field 714 may be used if the patient is using a computer program in accordance with an embodiment of the present invention in a mandatory compliance scenario, wherein the patient is required to send a picture of the medication to the caregiver to report the taking of the medication. The field 716 can be selected to indicate that the patient should receive a later reminder. The computer processor 4 and/or 104 may be programmed by a computer program stored in computer memory 8 and/or 108 to provide a reminder later in time, in an image similar to or identical to the image 702 in FIG. 7, except that the time would be different.

The processing of the selections of fields 714 and/or 716 is performed by the user computer processor 4 and/or the server computer processor 104 implementing one or more computer programs stored in the computer memory 8 and/or the computer memory 108.

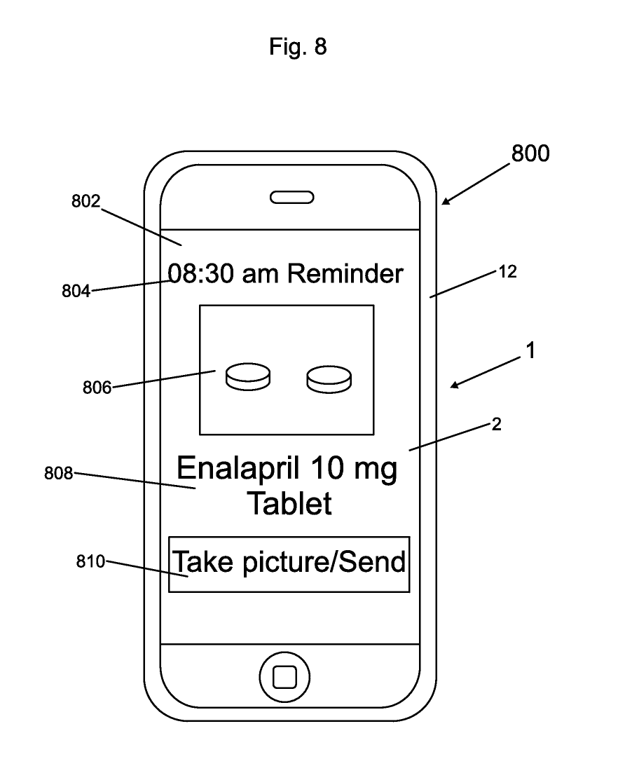

FIG. 8 shows a simplified diagram 800 of the user computer display 2 of the user computer 1 of FIG. 1A, with a sixth image 802 shown on the user computer display 2. The user computer processor 4 and/or the server computer processor 104 may cause the image 802 to be displayed on the computer display 2 in response to selection of the field 714 in FIG. 7, in accordance with a computer program or programs stored in computer memory 8 and/or computer memory 108. The user computer 1 is shown as a smart phone in FIG. 3. The image 802 may be displayed to required a patient to provide a picture to a caregiver to ensure that the patient has taken their medication.

The sixth image 802 includes text 804, image 806, text 808, and field 810. The text 804 indicates a time and the fact that this a reminder to take the drug referred to. The image 806 shows a picture of the drug of text 706 in tablet form. The text 808 includes the name of the drug, the dosage, and the form in which it is in. The field 810 can be selected to take a picture of the drug that has been taken and to send it, such as by email to a care giver.

The processing of the selections of field 810 is performed by the user computer processor 4 and/or the server computer processor 104 implementing one or more computer programs stored in the computer memory 8 and/or the computer memory 108.

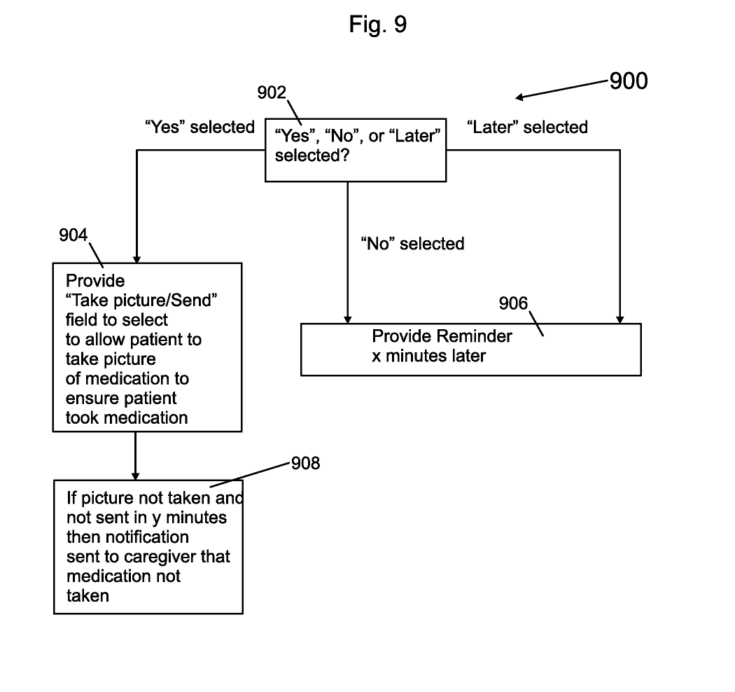

FIG. 9 shows a flow chart 900 of another method in accordance with another embodiment of the present invention. At step 902, the computer processor 4 and/or 104 determines if “Yes”, “No”, or “Later” was selected of fields 616, 618, and 620 in FIG. 6. The computer processor 4 and/or 104 may be programmed by computer software stored in computer memories 8 and/or 108 to provide a reminder x minutes later at step 906 of FIG. 9, if “No” or “Later” is selected by a user. If “Yes”, field 616 is selected, then at step 904 image 802 may be displayed by the computer processor 4 and/or 104 on the computer display 2. In at least one embodiment, if the user does not take a picture of the drug and sent it to the caregiver within a certain amount of time, such as y minutes, at step 908, such as by selecting field 810, then the computer processor 4 and/or 104 automatically sends a notification to the caregiver such as by text or email that the drug and/or medication has not been taken.

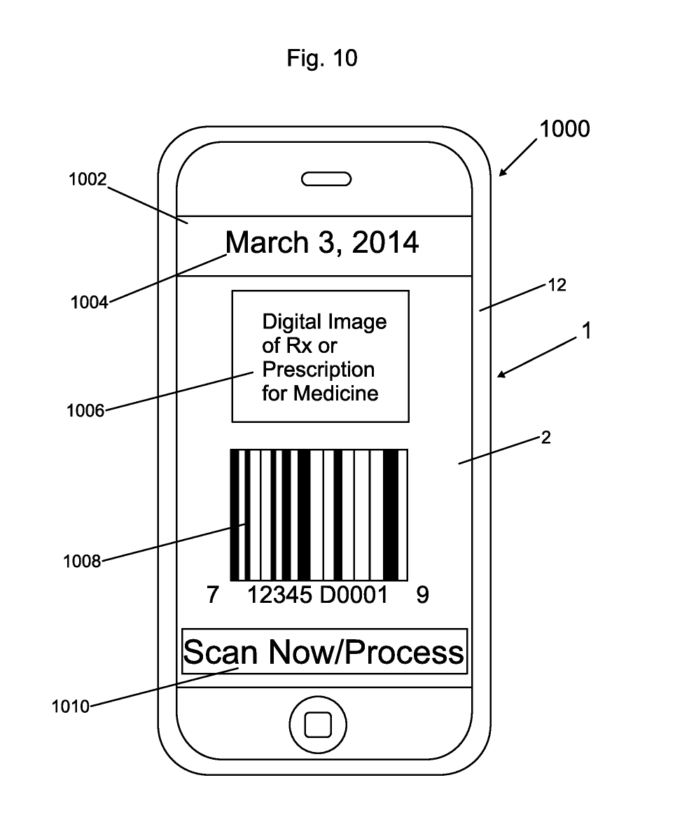

FIG. 10 shows a simplified diagram 1000 of the user computer display 2 of the user computer 1 of FIG. 1A, with a seventh image 1002 shown on the user computer display 2. The image 1002 includes a current date in field 1004, an image 1006 which may be an image of a hard copy written Rx or prescription for medicine which may have been scanned, a bar code 1008, and a field 1010. The field 1010 can be selected by a user to scan in a new prescription for medicine such as shown as image 1006.

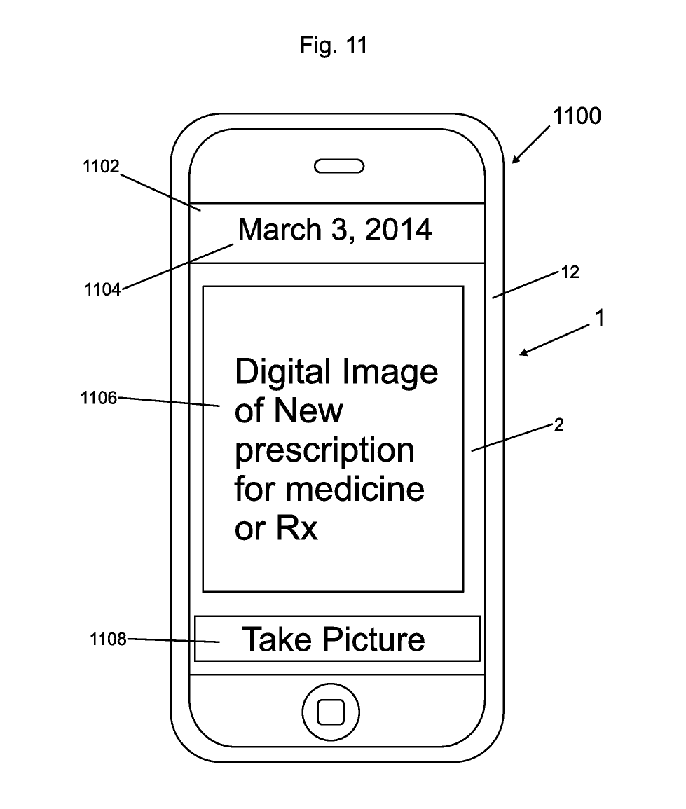

FIG. 11 shows a simplified diagram 1100 of the user computer display 2 of the user computer 1 of FIG. 1A, with a eighth image 1102 shown on the user computer display 2. The image 1002 includes a current date in field 1104, an image 1106 of a hard copy Rx or prescription for medicine, and a field 1108 for “Take Picture”. The field 1108 can be selected by a user to take a picture of a hard copy Rx or prescription for medicine and have it sent a pharmacy or pharmacy computer, or pharmacy computer account.

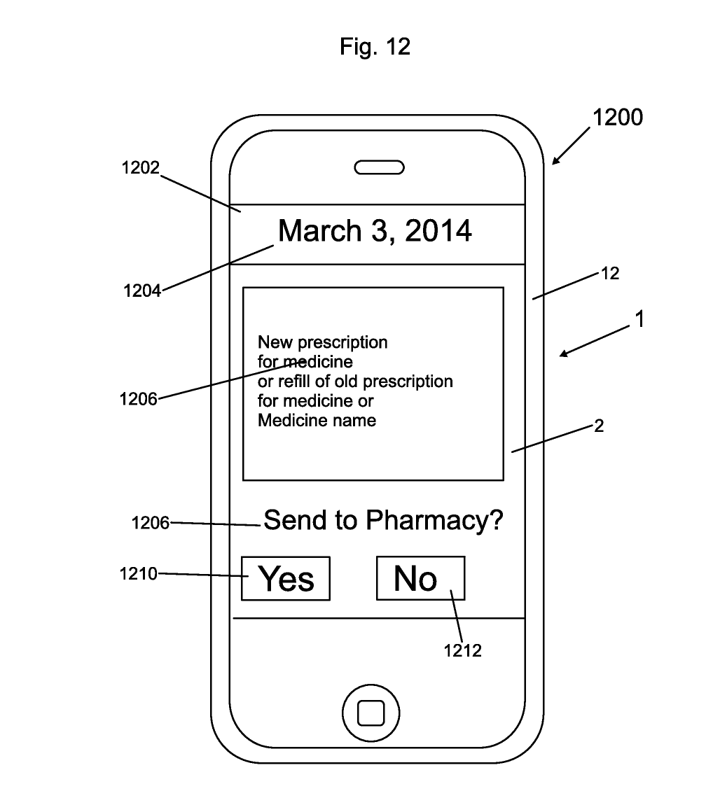

FIG. 12 shows a simplified diagram 1200 of the user computer display 2 of the user computer 1 of FIG. 1A, with a ninth image 1202 shown on the user computer display 2. The image 1202 includes a current date in field 1204, an image 1206 which may be of a new prescription of medicine, and old prescription of medicine or a picture of medicine, or medicine name, text 1206 for “Send to Pharmacy”, and fields 1210 and 1212. The field 1210 can be selected by a user to cause the computer processor 4 and/or 104 to send a picture of the drug or medication to a pharmacy, such as by email and/or text message, and the field 1212 can be selected by a user to not send a picture of the drug to a pharmacy.

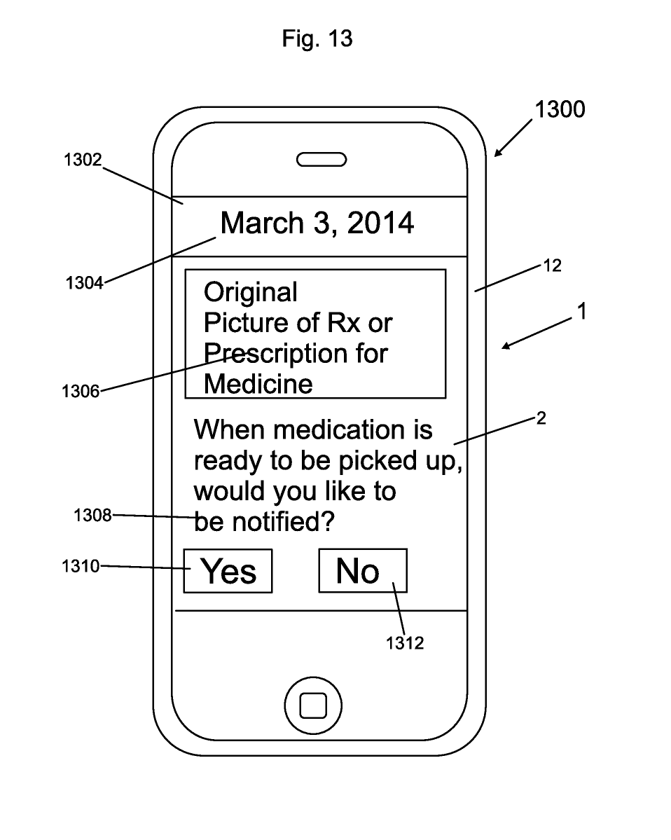

FIG. 13 shows a simplified diagram 1300 of the user computer display 2 of the user computer 1 of FIG. 1A, with a tenth image 1302 shown on the user computer display 2. The image 1302 includes a current date in field 1304, an image 1306, which may be of a particular medication, text 1308 for “When medication is ready to be picked up, would you like to be notified?”, and fields 1310 and 1312. The field 1310 can be selected by a user to cause the computer processor 4 and/or 104 to notify the patient when medication is ready to be picked up such as by email and/or text message, and the field 1310 to not notify the patient regarding pickup of medication.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A computer readable medium comprising computer executable instructions which, when executed by a computer processor, perform the steps of:
displaying a take photograph field on a mobile communications device computer display, wherein when the take photograph field is selected a digital photograph of a prescription for medicine is taken by the mobile communications device, and stored in a computer memory by the mobile communications device;
and sending data concerning the digital photograph from the mobile communications device to a pharmacist computer device via the internet.

2. The computer readable medium of claim 1 wherein the computer executable instructions when executed by the computer processor, additionally perform the step of:
displaying on the mobile communications device computer display a name and a dosage amount for the medicine.

3. The computer readable medium of claim 1 wherein the computer executable instructions when executed by the computer processor, additionally perform the step of:
displaying on the mobile communications device computer display a medicine taken field, wherein the medicine taken field when selected causes the mobile communications device to send a message to a caregiver computer device via the internet to indicate that the medicine has been taken.

4. The computer readable medium of claim 1 wherein the computer executable instructions when executed by the computer processor, additionally perform the step of:
displaying on the mobile communications device computer display a medicine not taken field, wherein the medicine not taken field when selected causes the mobile communications device to send a message to a caregiver computer device via the internet to indicate that the medicine has not been taken.

5. A method comprising the steps of:
taking a digital photograph of a prescription for medicine with a mobile communications device; and
sending data concerning the digital photograph from the mobile communications device to a pharmacist computer device via the internet.

6. The method of claim 5 further comprising
displaying on the mobile communications device computer display a name and a dosage amount for the medicine.

7. The method of claim 5 further comprising
displaying on the mobile communications device computer display a medicine taken field, wherein the medicine taken field when selected causes the mobile communications device to send a message to a caregiver computer device via the internet to indicate that the medicine has been taken.

8. The method of claim 5 further comprising
displaying on the mobile communications device computer display a medicine not taken field, wherein the medicine not taken field when selected causes the mobile communications device to send a message to a caregiver computer device via the internet to indicate that the medicine has not been taken.
